(19) United States
(12) Patent Application Publication
(10) Pub. No.: US 2025/0292761 A1
(43) Pub. Date: Sep. 18, 2025

(54) DEVICE THAT EMITS INTERMITTENT SOUND

(71) Applicant: Wolf Punch, Inc., Orange, CA (US)

(72) Inventor: Travis Walker Peterson, Orange, CA (US)

(21) Appl. No.: 19/071,568

(22) Filed: Mar. 5, 2025

Related U.S. Application Data
(60) Provisional application No. 63/564,851, filed on Mar. 13, 2024.

(51) Int. Cl. G10K 15/04

(52) U.S. Cl. CPC G10K 15/04

(57) ABSTRACT

The devices described herein can intermittently emit sound such as songs, animal sounds, human sounds, etc. to prank unsuspecting people. The devices can interface with powered devices for power, which can enable the devices to not have a battery. The electronics of the devices can be housed within a housing such that the devices are self-contained, which can make the devices discrete, readily concealable when transporting, and easy to handle when quickly interfacing with a powered device to prank. The devices can intermittently emit the sound at random or consistent intervals to confuse, perplex, embarrass, or discomfort the unsuspecting people as to the origin of the sound.

### INCORPORATION BY REFERENCE TO ANY PRIORITY APPLICATIONS

This application claims the priority benefit of U.S. Provisional Application No. 63/564,851, filed Mar. 13, 2024, which is incorporated by reference herein in its entirety. Any and all applications, if any, for which a foreign or domestic priority claim is identified in the Application Data Sheet of the present application is hereby incorporated by reference under 37 CFR 1.57.

### BACKGROUND

### Technical Field

This disclosure is directed to a device that emits intermittent sound, and more particularly, to a device that emits intermittent sound to play a prank on unsuspecting people.

### Description of Related Art

Friends and family play pranks on each other to cause temporary confusion, perplexity, embarrassment, or discomfort, which can result in a good laugh for all. With the advancement of technology, the technology employed to play pranks has advanced as well.

### SUMMARY

The present disclosure relates to devices that can emit intermittent sound(s) to temporarily confuse, perplex, embarrass, or discomfort unsuspecting people. The devices can emit a random sound, which can include a random sound from a library of sounds, or a predetermined sound. The devices can emit the sound at random intervals, which can include random within a range, or at consistent intervals. The devices can interface with a power source (e.g., electronic devices, electrical devices, outlet) for power. The electronics of the devices can be housed within a housing such that the devices are self-contained, which can make the devices discrete for undetected planting and transport. In some variants, the devices can be USB devices that have a USB plug that can interface with a USB port of a power source. In some variants, the devices can be an outlet adapter or outlet device that can interface with an outlet, such as a wall outlet, for power while providing pass through power for other electronic devices plugged into the outlet adapter.

In some variants, the techniques described herein relate to a USB device for pranking an unsuspecting person, the USB device including: a housing; a USB connector configured to interface with a USB port of a device to power the USB device; a loudspeaker disposed within the housing; a user interface accessible outside of the housing, the user interface configured to be manipulated by a user to set a range of interval lengths; and a controller connected to a physical memory disposed in the housing that includes instructions that, when executed by the controller, cause: the user interface to receive input from the user; the controller to interpret the input; and the loudspeaker to intermittently emit sound at random intervals within the set range of interval lengths.

In some variants, the techniques described herein relate to a USB device, wherein the USB device does not operate when not interfaced with the USB port of the device.

In some variants, the techniques described herein relate to a USB device, wherein the user interface is configured to be manipulated by the user to select the sound.

In some variants, the techniques described herein relate to a USB device and 2, wherein the instructions, when executed by the controller, cause the loud speaker to intermittently emit random sound.

In some variants, the techniques described herein relate to a USB device, wherein the random sound is randomly selected from a plurality of sounds.

In some variants, the techniques described herein relate to a USB device, wherein the user interface is configured to be manipulated by the user to establish the plurality of sounds.

In some variants, the techniques described herein relate to a USB device, wherein the sound is music, an animal sound, or a human sound.

In some variants, the techniques described herein relate to a USB device, wherein the housing includes a rectangular prism shape.

In some variants, the techniques described herein relate to a USB device, wherein the housing includes one or more apertures through which sound emitted by the loudspeaker can travel.

In some variants, the techniques described herein relate to an USB device for pranking an unsuspecting person, the USB device including: a housing; a USB connector configured to interface with a USB port of a device to power the USB device; a loudspeaker disposed within the housing; and a controller connected to a physical memory disposed in the housing that includes instructions that, when executed by the controller, cause the loudspeaker to intermittently emit a sound at random interval lengths.

In some variants, the techniques described herein relate to a USB device, wherein the USB device does not operate when not interfaced with the USB port of the device.

In some variants, the techniques described herein relate to a USB device, wherein the random interval lengths are within a range of interval lengths.

In some variants, the techniques described herein relate to a USB device, further including a user interface configured to be manipulated by a user to set the range of interval lengths.

In some variants, the techniques described herein relate to a USB device, wherein the sound is random.

In some variants, the techniques described herein relate to a USB device, wherein the sound is randomly selected from a plurality of sounds.

In some variants, the techniques described herein relate to an outlet device for pranking an unsuspecting person, the outlet device including: a housing; a connector configured to operatively connect with an interface of a power source to receive electrical current to power the outlet device; one or more outlets configured to interface with another device to provide electrical current received by the outlet device to the another device; a loudspeaker disposed within the housing; and a controller connected to a physical memory disposed in the housing that includes instructions that, when executed by the controller, cause the loudspeaker to intermittently emit sound.

In some variants, the techniques described herein relate to an outlet device, wherein the power source comprises a wall outlet.

In some variants, the techniques described herein relate to an outlet device, wherein the connector includes prongs.

In some variants, the techniques described herein relate to an outlet device, wherein the housing comprises a front face, the front face comprising the one or more outlets and one or more apertures through which the intermittently emitted sound is projected.

In some variants, the techniques described herein relate to an outlet device, wherein the instructions, when executed by the controller, cause the loudspeaker to intermittently emit the sound at random interval lengths.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates a device that can emit intermittent sound.

FIG. 2 illustrates a system diagram of the device of FIG. 1.

FIG. 3 illustrates the device with a user interface.

FIG. 4 illustrates the user interface.

FIG. 5A illustrates the device interfacing with a computing device for power.

FIG. 5B illustrates the device interfacing with an electrical device for power.

FIG. 5C illustrates the device interfacing with a vehicle for power.

FIG. 5D illustrates the device interfacing with a wall outlet for power.

FIG. 5E illustrates a port at a wall outlet that the device can interface with for power.

FIG. 6A illustrate a front view of a device that can emit intermittent sound.

FIG. 6B illustrates a rear view of the device of FIG. 6A.

FIG. 7A illustrates a front view of a device that can emit intermittent sound.

FIG. 7B illustrates a rear view of the device of FIG. 7A.

FIG. 8 illustrates a system diagram of device of FIGS. 7A and 7B.

### DETAILED DESCRIPTION OF EMBODIMENTS

Example embodiments described herein have several features, no single one of which is indispensable or solely responsible for their desirable attributes. Without limiting the scope of the claims, some of the advantageous features of some embodiments will be described.

Some variants relate to devices that can emit intermittent sound. The devices can emit a random sound or a predetermined sound. The devices can emit the sound at random intervals or at consistent intervals. The devices can interface with a power source (e.g., powered device) for power, which can enable the devices to have no battery. The electronics of the devices can be housed within a housing such that the devices are self-contained, which can make the devices discrete, readily concealable when transporting, and easy to handle when quickly interfacing with a powered source to prank.

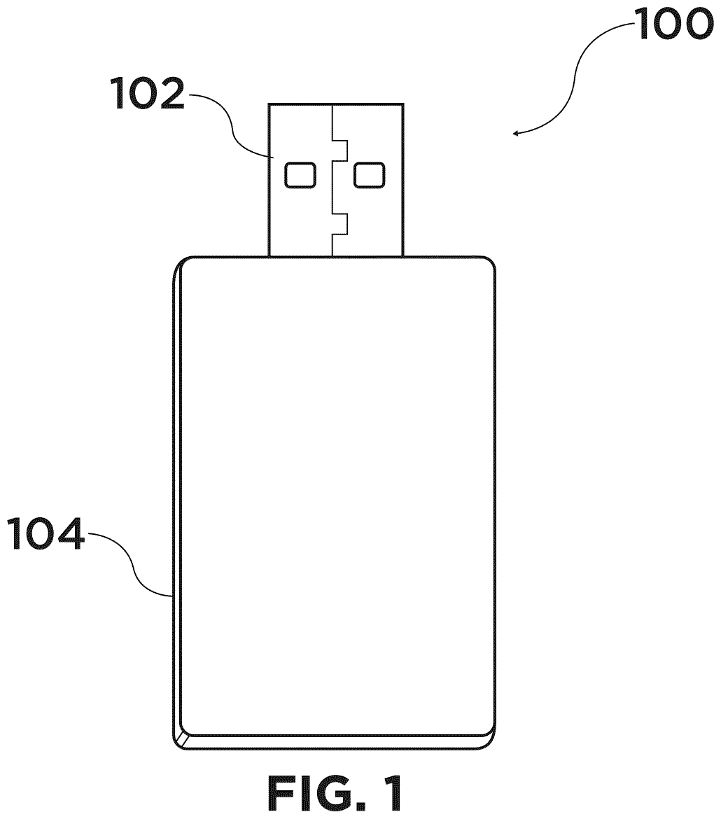

FIG. 1 illustrates a device 100 that can emit intermittent sound. The device 100 can also be referred to as a system, USB device, and/or prank device. The device 100 can include an interface 102, which can be a connector, USB connector (e.g., USB 2.0/1.0 Type-A, USB 2.0 Type-B, USB 3.0 Type-A, USB 2.0 Mini-A, USB 2.0 Mini-B, USB 3.0 Type-C, USB 2.0 Micro-A, USB 2.0 Micro-B, USB 3.0 Micro-B, etc.), plug, and/or head. The interface 102 of the device 100 can interface (e.g., be inserted into, couple with) with the interface of a power source (e.g., electronic device, electrical device, outlet) to power the device 100 such that the device 100 can have no battery. In some variants, the device 100 can only operate when interfaced with a power source. The power source can power the electronics of the device 100, which can be disposed inside of a housing 104 (e.g., covering, shell, cover, enclosure) of the device 100. The housing 104 can include varying shapes, which can at least include polygonal (e.g., rectangular prism). The housing 104 can include rounded corners and/or edges. The device 100 can be held in a user's hand or pocket for discrete transport and handling.

The device 100, as described herein, can interface with a power source to emit intermittent sound. The intermittent sound can be a variety of sounds. Non-limiting examples of such sounds include songs (e.g., Baby Shark, etc.), animal sounds (e.g., cricket chirping, goat screaming, cat meowing, dog barking, bird screeching, etc.), human sounds (e.g., flatulating, belching, screaming, yelling, etc.), machine sounds (e.g., vehicle honking, etc.), weather sounds (e.g., thunder, etc.), and/or others. In some variants, the device 100 can only emit one sound (e.g., cricket chirping). In some variants, the device 100 can play a plurality of sounds. In some variants, the device 100 can randomly emit a sound from a plurality of sounds such that sequentially emitted sounds may be different. In some variants, the device 100 can randomly emit a sound from a subset of sounds set (e.g., selected) by the user from a plurality of sounds. In some variants, the user can choose one sound from a plurality of sounds that is emitted by the device 100. In some variants, the user can record a sound that is then emitted by the device 100. In some variants, the user can download a sound to the device 100 that is then emitted by the device 100.

The device 100, as described herein, can emit sound intermittently. In some variants, the interval of time between emitted sounds can be consistent. For example, the interval of time can be a set number of seconds (e.g., less than 10, 10, 20, 30, 40, 50, 60, or more than 60 seconds or any value between any of the foregoing), minutes (e.g., less than 1, 1, 2, 3, 4, 5, 10, 20, 30, 40, 50, 60, or more than 60 minutes or any value between any of the foregoing), hours (e.g., less than 1, 1, 2, 3, or more than 3 hours or any value between any of the foregoing), or days (e.g., less than 1, 1, 2, 3, or more than 3 days or any value between any of the foregoing). In some variants, the interval of time between emitted sounds can be random. For example, the interval between a first two emitted sounds may be 2 minutes while the interval between a second two emitted sounds may be 5 minutes. In some variants, the interval of time between emitted sounds can be random within a range, which can be set (e.g., selected) by the user. For example, the user may set (e.g., select) a range of 5-15 minutes such that the device 100 emits sounds at random intervals within 5-15 minutes of each other. In some variants, the user may set (e.g., select) a time interval (e.g., 10 minutes) which corresponds to a range (e.g., 5-15 minutes) encompassing the set time interval such that the device 100 emits sounds at random intervals within the range. Example time intervals include a number of seconds (e.g., less than 10, 10, 20, 30, 40, 50, 60, or more than 60 seconds or any value between any of the foregoing), minutes (e.g., less than 1, 1, 2, 3, 4, 5, 10, 20, 30, 40, 50, 60, or more than 60 minutes or any value between any of the foregoing), hours (e.g., less than 1, 1, 2, 3, or more than 3 hours or any value between any of the foregoing), or days (e.g., less than 1, 1, 2, 3, or more than 3 days or any value between any of the foregoing). In some variants, the device 100 can emit a sound continuously (e.g., without stopping).

In some variants, the device 100 can emit sound for a consistent duration (e.g., same amount of time) at each intermittent emittance. In some variants, the device 100 can emit sound for a random duration at each intermittent emittance. In some variants, the random duration can be within a range, which can be set (e.g., selected) by the user. In some variants, the user may set (e.g., select) a duration (e.g., 3 seconds) which corresponds to a range (E.g., 1-5 seconds) such that the device 100 emits sound for random durations within the range.

In some variants, the device 100 can emit sound intermittently in perpetuity so long as the device 100 is interfaced with a power source (e.g., receiving power from a power source). In some variants, the device 100 can emit sound intermittently for a period of time so long as the device 100 is interfacing with a power source, which period of time can be set (e.g., selected) by the user. In some variants, the device 100 can emit sound intermittently for a random period of time so long as the device 100 is interfacing with a power source, which can include a random period of time within a range (e.g., a range set by the user such as 5 hours). In some variants, the device 100 may only emit sound intermittently during a certain time of day (e.g., business hours, after business hours, mornings, afternoons, nights, etc.), which can include randomly emitting sound intermittently during the certain time of day. The certain time of day may be set by the user. In some variants, the device 100 may only emit sound intermittently during certain days (e.g., Mondays, Fridays, Sundays, etc.), which can be selected by the user. In some variants, the device 100 may only emit sound intermittently during random days, which can include random within a subset of days set (e.g., selected) by the user.

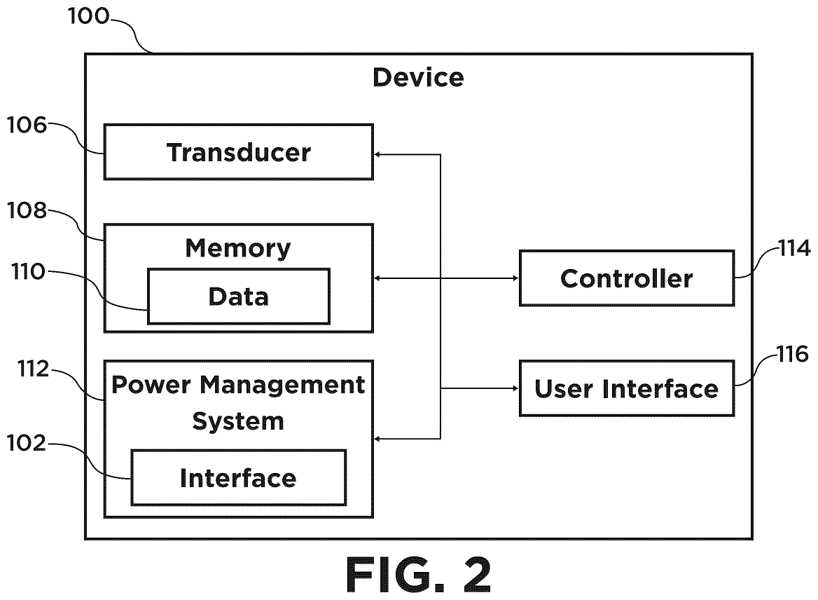

FIG. 2 illustrates a system diagram of the device 100. The architecture of the device 100 can include an arrangement of hardware and software components used to implement aspects of the present disclosure. The device 100 may include more or fewer elements than those shown in FIG. 2. It is not necessary, however, that all of these elements be shown in order to provide an enabling disclosure.

As illustrated, the device 100 can include a transducer 106 (e.g., loudspeaker and/or microphone), a memory 108 (e.g., memory system), a power management system 112 with the interface 102, controller 114, and/or user interface 116, which can communicate with one another by way of a data communication technique. The transducer 106, memory 108, controller 114, and/or power management system 112 can be disposed inside of the housing 104. In some variants, the interface 102 can be positioned at least partially outside of the housing 104 to facilitate interfacing with other devices. In some variants, the user interface 116 can be positioned at least partially outside of the housing 104 for accessibility.

The user interface 116 can include one or more buttons, dials, switches, toggles, knobs, touch screens, displays, sliders, etc. A user can interact with (e.g., push, pull, move, press, manipulate, touch, slide, etc.) the user interface 116 to control the device 100. A user can interact with the user interface 116 to adjust characteristics of the sound emitted by the transducer 106 of the device 100.

In some variants, the user can interact with the user interface 116 to change the sound emitted by the transducer 106. For example, the user can interact with the user interface 116 (e.g., push a button) to cycle through sound options and stop on the desired sound to be intermittently emitted by the transducer 106. In some variants, the user can interact with the user interface 116 to record a sound by way of the transducer 106 to be intermittently emitted by the transducer 106. In some variants, the user can interact with the user interface 116 to set a plurality of sounds to be intermittently emitted by the transducer 106, which can include consistently or randomly cycling through the plurality of sounds. In some variants, the user cannot change the sound emitted by the transducer 106 (e.g., the data 110 only includes sound data for one sound, such as a cricket chirping).

In some variants, a user can interact with the user interface 116 to adjust a volume of the sound emitted by the transducer 106. In some variants, the user can interact with the user interface 116 to set a range of volumes at which the transducer 106 can emit the sound, which can include the transducer 106 emitting the sound at a random volume within the set range of volumes.

In some variants, a user can interact with the user interface 116 to adjust the interval of time between emitted sounds. In some variants, the user can interact with the user interface 116 to set (e.g., select) a consistent interval of time between emitted sounds. In some variants, the user can interact with the user interface 116 to set (e.g., select) a range for the interval of time between emitted sounds and the device 100 can randomly emit sounds at intervals within the set range. In some variants, the user can interact with the user interface 116 to set a time interval that corresponds to a range that the device 100 can randomly emit sounds within.

In some variants, a user can interact with the user interface 116 to set a duration for the sound to be emitted by the transducer 106. In some variants, the user can interact with the user interface 116 to set (e.g., select) a consistent duration for the sound when emitted by the transducer 106. In some variants, the user can interact with the user interface 116 to set (e.g., select) a range for the duration of the sound when emitted by the transducer 106 and the device 100 can emit sounds for random durations within the set range. In some variants, the user can interact with the user interface 116 to set a duration for the emitted sound that corresponds to a duration range, and the device 100 can emit sound for a random duration within the duration range.

In some variants, a user can interact with the user interface 116 to set (e.g., select) a period of time during which the device 100 can emit sound intermittently so long as the device 100 is interfacing with a power source. In some variants, the user can interact with the user interface 116 to set (e.g., select) a range for the period of time and the device 100 can emit sound intermittently for a random period of time within the range. In some variants, a user can interact with the user interface 116 to set (e.g., select) a certain time of day in which the device 100 can emit sound, which can include randomly emitting sound intermittently during the certain time of day set by the user. In some variants, a user can interact with the user interface 116 to set (e.g., select) certain days in which the device 100 can intermittently emit sound, which can include the device 100 emitting sound intermittently on random days within the certain days set by the user.

The user, in some variants, can interact with the user interface 116 to turn the device 100 on or off. In some variants, the device 100 does not include a user interface 116 to turn the device 100 on or off, but instead, the device 100 is on and powered when interfacing with a power source and is off and not powered when not interfacing with a power source.

The memory 108 can include data 110 (e.g., sound data), instructions, and/or operations. The data 110 can include sound data for the one or more sounds to be emitted by the transducer 106 of the device 100. The memory 108 can include RAM, ROM, and/or other persistent auxiliary or non-transitory computer-readable media. The controller 114 can execute instructions on the memory 108 to implement one or more features, processes, steps, actions, etc. described herein. The memory 108 can include instructions that, when executed by the controller 114, can cause the device 100 to receive input from the user interface 11 and/or interpret the input received from the user interface 116 and execute instructions based on the input. The memory 108 can include instructions that, when executed by the controller 114, can cause the transducer 106 to emit one or more sounds, which can include intermittently, at various intervals, durations, periods of time, etc. as described herein. The controller 114 can include one or more timer(s) and/or be in communication with one or more timer(s).

The interface 102, as described herein, can interface with a power source to power the device 100. The device 100 can include a power management system 112 to manage the electrical power provided to the device 100 by the interface 102. As described herein, in some variants, the device 100 can provide pass through power to another device interfacing with the device 100. In some variants, the interface 102 can interface with a data interface of an electronic device, such as a computing device, to facilitate data communication between the device 100 and the computing device. For example, in some variants, sound data can be communicated from the computing device to the device 100 and saved in the memory 108 to be emitted by the transducer 106.

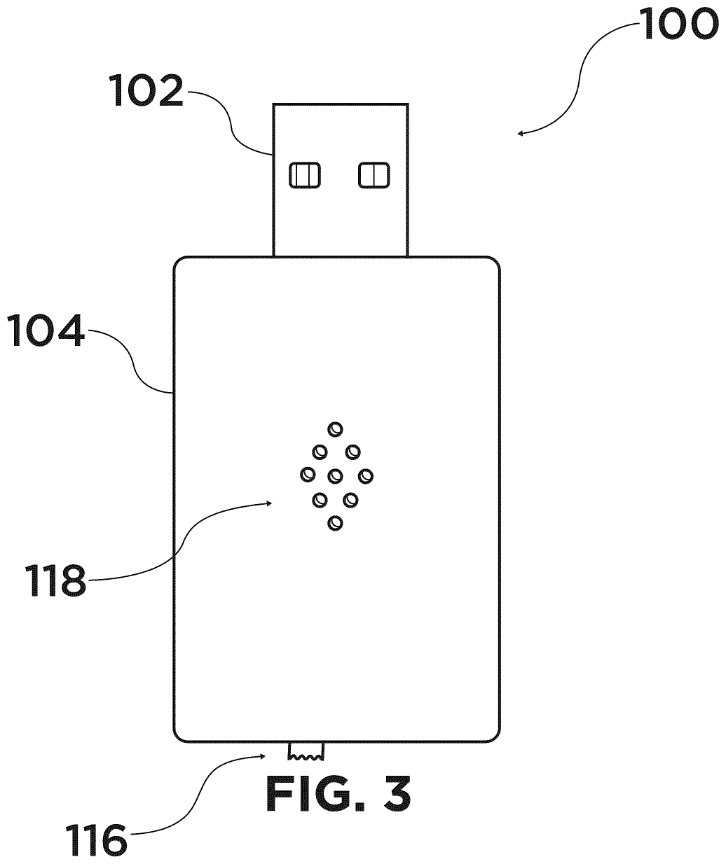

FIG. 3 illustrates the device 100 with the user interface 116. As illustrated, the user interface 116 can be a switch 116 that can be manipulated by the user to control a characteristic of the sound emitted by the transducer 106. The switch 116 can be at least partially disposed outside of the housing 104, which can include projecting out an end of the housing 104 opposite the interface 102. The housing 104 can include one or more aperture(s) 118 to improve the travel of sound emitted by the transducer 106 out of the housing 104.

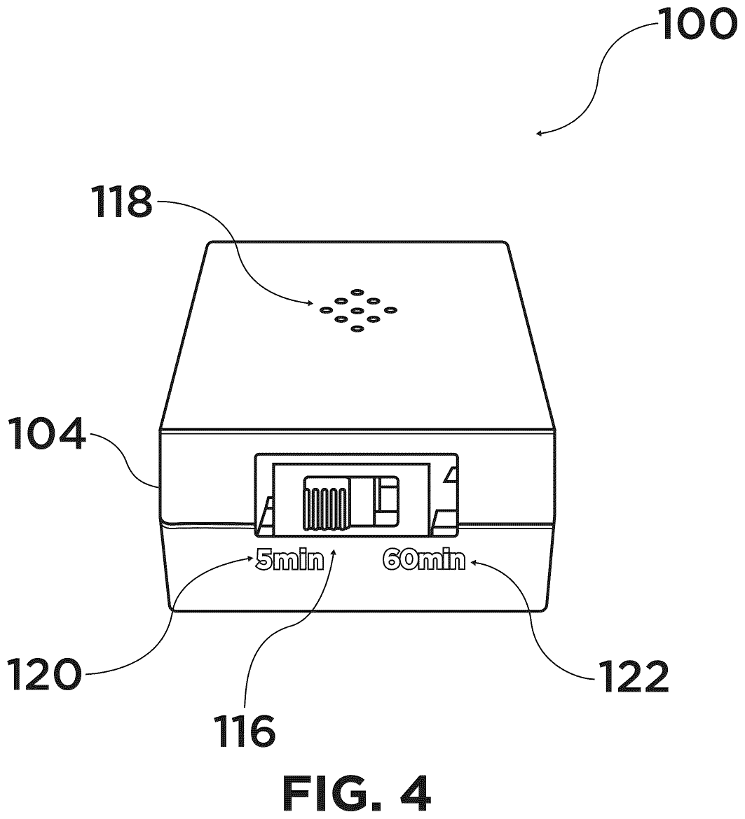

FIG. 4 illustrates an enlarged view of the switch 116 shown in FIG. 3. As shown, the switch 116 can be manipulated (e.g., toggled, moved) by a user between at least two options to set the length of the interval of time between the device 100 emitting a sound. For example, the switch 116 can be moved to a first configuration (e.g., position) which may correspond to a shorter length of time (e.g., 5 minutes) for the interval (e.g., first mode), as illustrated in FIG. 4, and a second configuration (e.g., position) which may correspond to a longer length of time (e.g., 60 minutes) for the interval (e.g., second mode). The device 100 can include indications (e.g., labels, descriptors, time durations, text, symbols, graphics, etc.) to indicate to a user the configuration of the switch 116. For example, the device 100 can include a first indication 120 and/or a second indication 122 to show that when the switch 116 is moved toward the first indication 120 the device 100 is in the first configuration (e.g., first mode) and when the switch 116 is moved toward the second indication 120 the device 100 is in the second configuration (e.g., second mode). In some variants, the first configuration may correspond to a consistent first interval length while the second configuration may correspond to a consistent second interval length such that, with the switch 116 in the first configuration, the device 100 emits a sound consistently at the first interval length (e.g., 5 minutes) and, with the switch 116 in the second configuration, the device 100 emits a sound consistently at the second interval length (e.g., 60 minutes). In some variants, the first configuration may correspond to a first range of interval lengths and the second configuration may correspond to a second range of interval lengths and, with the switch 116 in the first configuration, the device 100 can emit sounds at random interval lengths within the first range of interval lengths and, with the switch 116 in the second configuration, the device 100 can emit sounds at random interval lengths within the second range of interval lengths. For example, moving the switch 116 to a first configuration with the switch 116 at a 5 minute indication can correspond to a first range of interval lengths from 2 to 7 minutes, and the device 100 can emit sounds at random interval lengths between 2 and 7 minutes. Similarly, moving the switch 116 to a second configuration with the switch 116 at a 60 minute indication can correspond to a second range of interval lengths from 55 to 65 minutes, and the device 100 can emit sounds at random interval lengths between 55 and 65 minutes. In some variants, the user interface 116 can include a plurality (e.g., 2, 3, 4, 5, 6, 7, 8, or more than 8) of interval options that the user can set (e.g., select), which, when set, can correspond to consistent interval lengths between sounds or ranges of interval lengths. When corresponding to a range of interval lengths, the device 100 can emit sound at random interval lengths within the range of interval lengths. In some variants, the user interface 116 can include a continuum of interval options between two end interval lengths, wherein each option along the continuum including the ends can correspond to consistent interval lengths or a range of interval lengths for random selection. In some variants, the first indication 120 can indicate 5 minutes. In some variants, the second indication 122 can indicate 60 minutes.

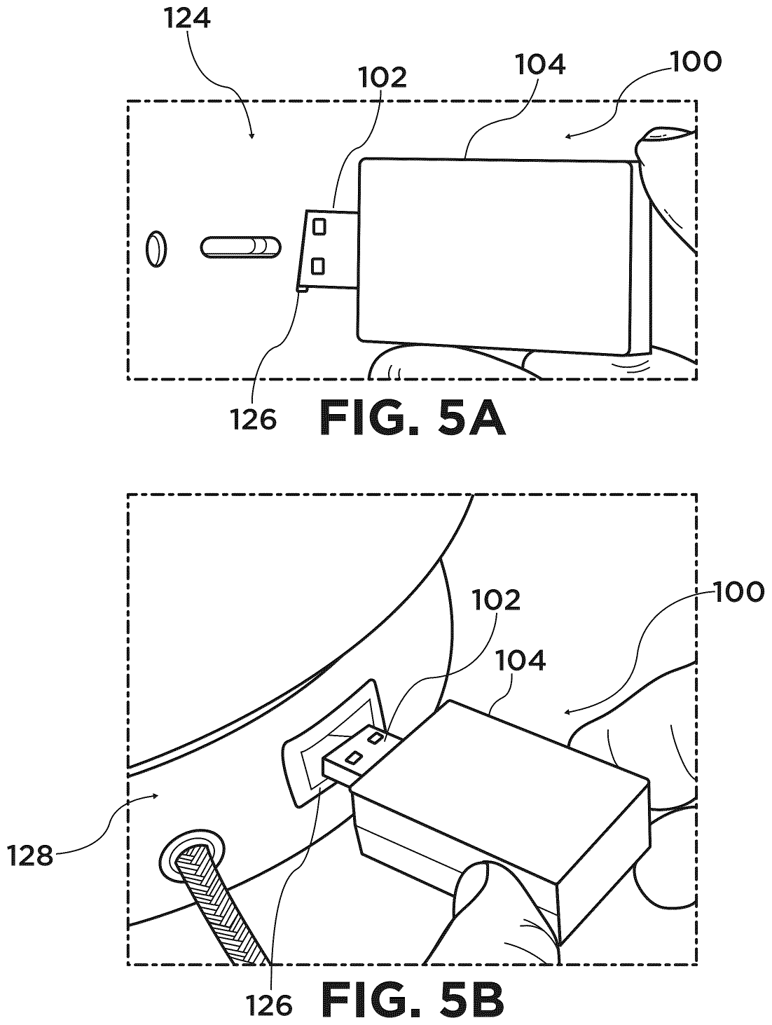

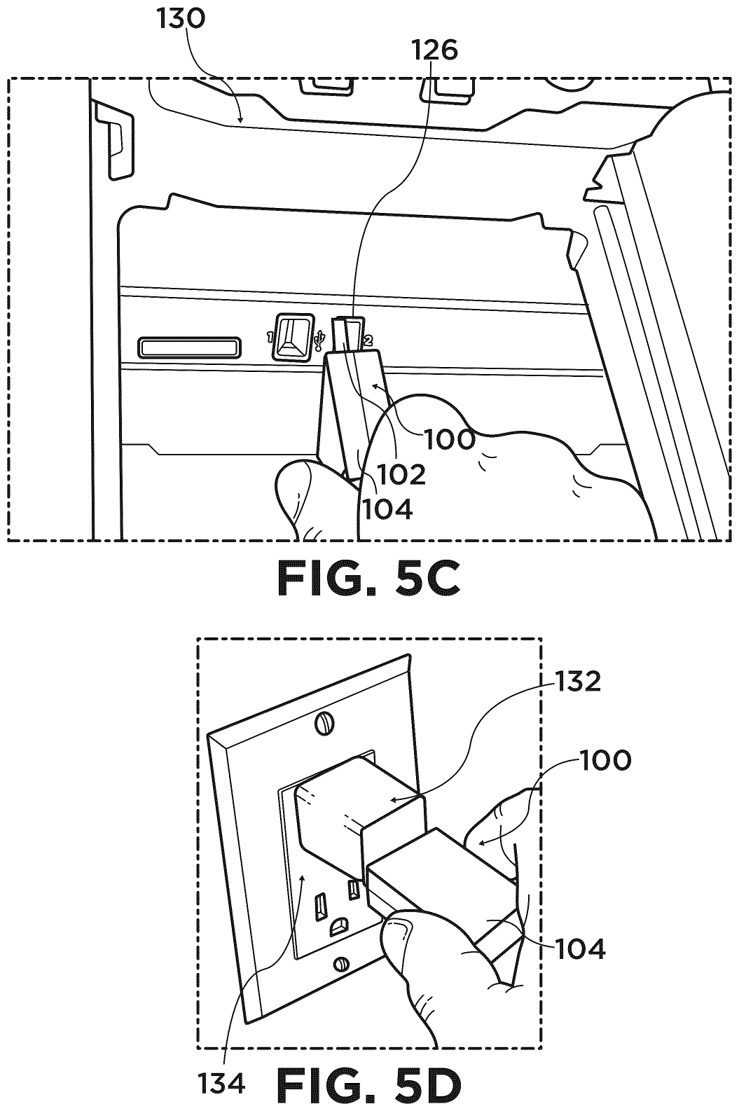

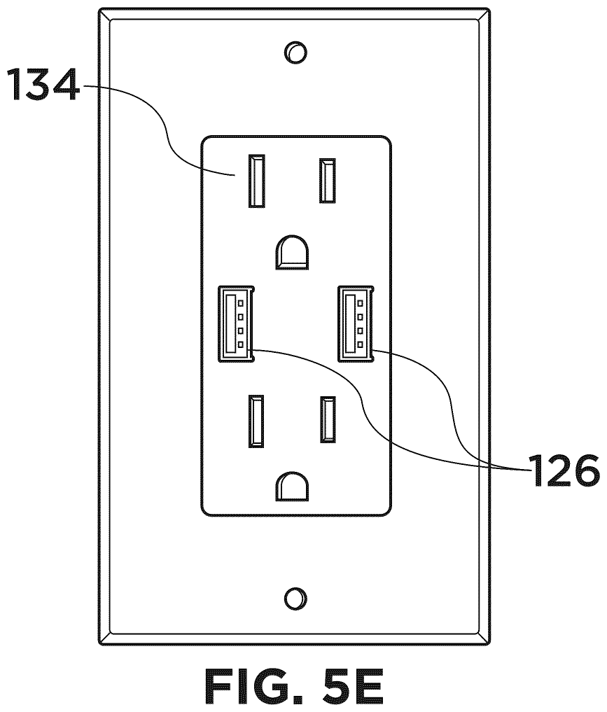

As described herein, the interface 102 of the device 100 can interface with another device to provide electrical power to the device 100 to operate. For example, as illustrated in FIG. 5A, the interface 102 (e.g., USB connector) of the device 100 can interface with (e.g., be inserted into) the interface 126 (e.g., USB port) of a computing device 124 (e.g., desktop, monitor, laptop, etc.) to power the device 100. As illustrated in FIG. 5B, the interface 102 (e.g., USB connector) can interface with (e.g., be inserted into) the interface 126 (e.g., USB port) of an electrical device 128 (e.g., lamp, alarm clock, etc.) to power the device 100. As illustrated in FIG. 5C, the interface 102 (e.g., USB connector) of the device 100 can interface with (e.g., be inserted into) the interface 126 (e.g., USB port) of a vehicle 130 (e.g., automobile, aircraft, etc.) to power the device 100. As illustrated in FIG. 5D, the interface 102 (e.g., USB connector) of the device 100 can interface with (e.g., be inserted into) the interface (e.g., USB port) of an outlet adapter 132 (e.g., USB outlet adapter) to power the device 100. FIG. 5E illustrates a wall outlet 134 with accompanying interfaces 126 (e.g., ports, USB ports) that the interface 102 (e.g., USB connector) of the device 100 can interface with (e.g., be inserted into) to power the device 100.

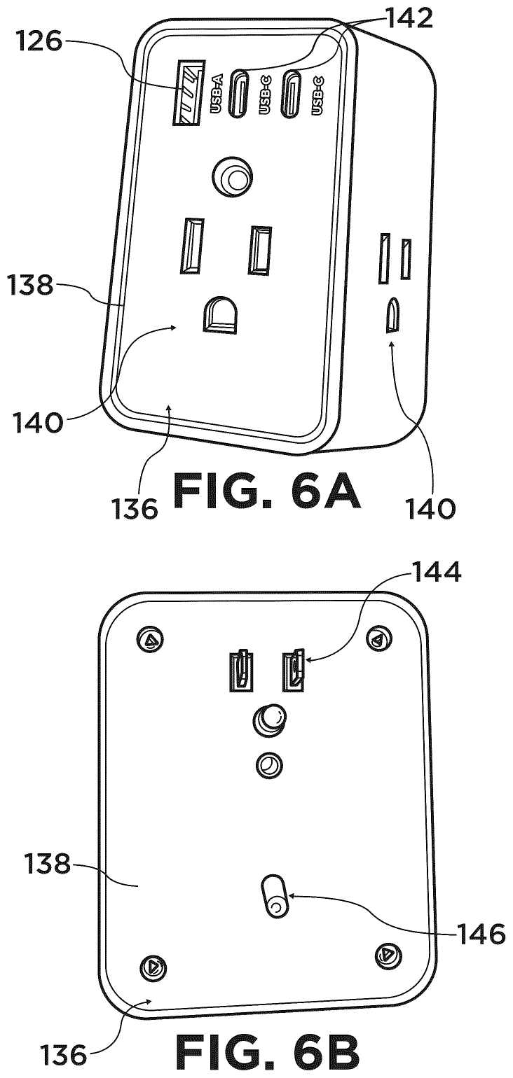

FIGS. 6A and 6B illustrate a device 136, which can be a referred to as a system, prank device, outlet device, plug device, pass-through-power device, and/or outlet adapter device. The device 136 can include any of the features described in reference to device 100. The device 136 can include any of the functionality described in reference to the device 100 (e.g., emit intermittent sounds at consistent or random intervals, etc.).

The device 136 can provide pass through power from a wall outlet or other power source, which can include a cord, power bank, outlet, etc., to another device while powering the device 136. The device 136 can include an interface 144 (e.g., connector, prongs) to interface with (e.g., be inserted into) corresponding holes of the wall outlet to power the device 136. The device 136 can include a false prong 146 to interface with (e.g., be inserted into) a corresponding hole of the wall outlet to stabilize the device 136 relative to the wall outlet. The device 136 can include one or more interfaces to provide pass through power from a wall outlet to one or more other devices. For example, the one or more interfaces can include one or more outlets 140 (e.g., socket(s), receptacle(s), etc.), ports 126, ports 142, etc. The device 136 can include a housing 138 that can, like the housing 104 for device 100, house the electronic components of the device 136. The device 136 can appear like an outlet adapter or smart plug to conceal its prank abilities described herein (e.g., emitting sounds at random intervals) to help avoid detection.

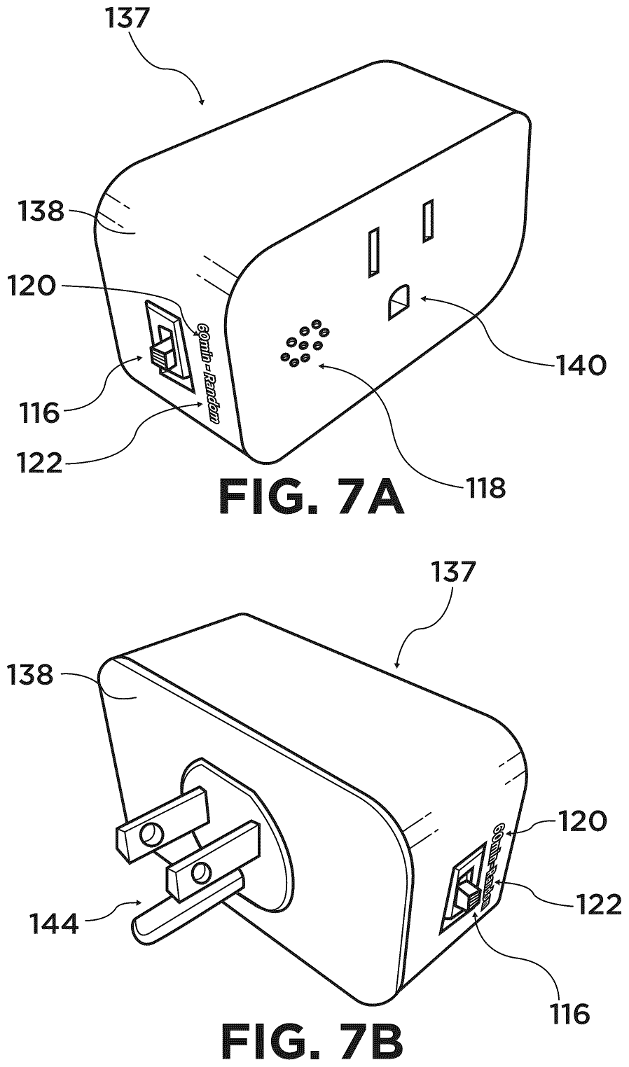

FIGS. 7A and 7B illustrate a device 137, which can be referred to as a system, prank device, plug device, outlet device, pass-through-power device, and/or outlet adapter device. The device 137 can include any of the features described in reference to devices 100 and/or 136. The device 137 can include any of the functionality described in reference to the devices 100 and/or 136 (e.g., emit intermittent sounds at consistent or random intervals, etc.).

The device 137, like the device 136, can provide pass through power from a wall outlet or other power source to another device while powering the device 137. The 137 can include an interface 144 (e.g., connector, prongs) to interface with (e.g., be inserted into) corresponding holes of a wall outlet or other device to power the device 137. The device 137 can include one or more interfaces to provide pass through power from the wall outlet or other device to one or more other devices. For example, the one or more interfaces can include one or more outlets 140. The device 137 can include a housing 138 that can house internal components, such as electronic components, of the device 137. The device 137 can appear like an outlet adapter or smart plug to conceal its prank abilities described herein (e.g., emitting sounds at random intervals to help avoid detection).

The device 137, like the device 100, can include a user interface 116 (e.g., switch). A user can interact with (e.g., manipulate, move, etc.) the user interface 116 to select a configuration (e.g., mode) of the device 137 as described herein, which can include selecting a sound to be emitted by the device 137, a frequency at which the sound is emitted, a range for the frequency at which the sound is emitted, etc. For example, the device 137 can include the first indication 120 and/or the second indication 122 as described herein with respect to device 100. In some variant, the first indication 120 can indicate 60 minutes and/or the second indication 122 can indicate random. In some variants, 60 minutes can indicate that a sound will be emitted every 60 minutes. In some variants, 60 minutes indication can correspond to a range of interval lengths from 55 to 65 minutes, and the device 137 can emit sounds at random interval lengths between 55 and 65 minutes. In some variants, random can indicate that a sound will be randomly emitted, which can include being randomly emitted a limit. For example, a sound can be randomly emitted within a set time (e.g., seconds, minutes, hours, days, etc.) of the device 137 being powered, the last sound emission by the device 137, and/or the device 137 being placed in the random configuration. The user interface 116 can be disposed on a front face of the housing 138 (e.g., same face as location of one or more outlets 140), a side wall (e.g., peripheral wall, wall extending between front and back faces, etc.) of the housing 138, or a rear face of the housing 138 (e.g., same face as location of one or more interfaces 144).

The housing 138 can include one or more aperture(s) 118 through which the transducer 106 disposed within the housing 138 can emit sound. The one or more aperture(s) 118 can be in different quantities and/or shapes. The aperture(s) 118 can be disposed on the front face of the housing 138, which can be the same face as the one or more outlets 140. In some variants, the one or more aperture(s) 118 can be disposed through a side wall (e.g., peripheral wall, wall extending between front and back faces, etc.) of the housing 138.

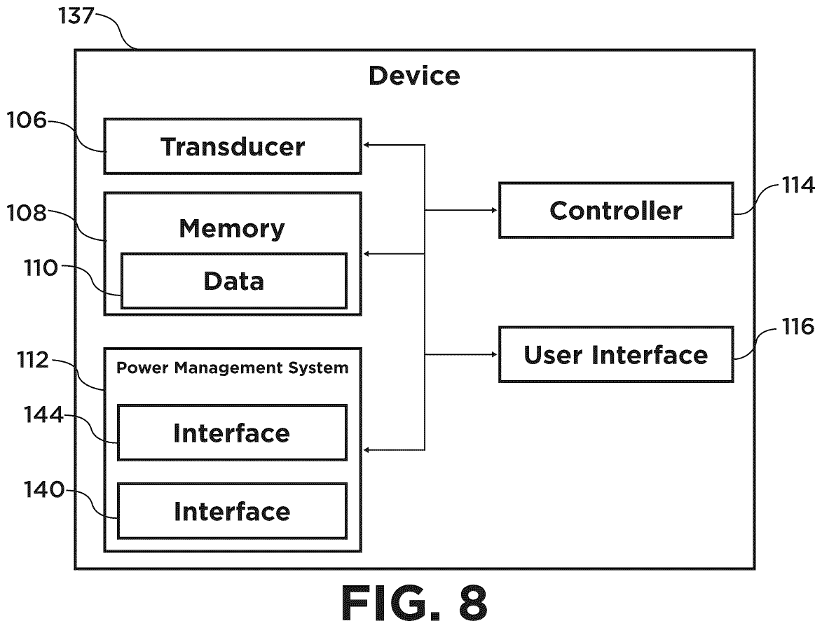

FIG. 8 illustrates a system diagram of the device 137. The architecture of the device 137 can include an arrangement of hardware and software components used to implement aspects of the present disclosure. The device 137 may include more or fewer elements than those shown in FIG. 8. It is not necessary, however, that all of these elements be shown in order to provide an enabling disclosure. The device 137, as described herein, can include any of the features described in reference to the device 100 and/or 136.

The device 137 can include a transducer 106 (e.g., loudspeaker and/or microphone), a memory 108 (e.g., memory system), a power management system 112 with the interface 144 (e.g., prongs) and/or interface 140 (one or more outlets), controller 114, and/or user interface 116, which can communicate with one another by way of a data communication technique. The power management system 112 can receive power by way of the interface 144 (e.g., prongs). The power management system 112 can pass power (e.g., alternating current) received by the interface 144 to a device interfaced with (e.g., plugged into) the interface 140 (e.g., one or more outlets) to provide pass through power. The power management system 112 can, in some variants, allocate power (e.g., alternating current) received by the interface 144 to power the device 137. In some variants, the power management system 112 can include an AC-DC converter to convert alternating current received by the interface 144 to direct current to power the device 137.

In some variants, the devices 100, 136, and/or 137 can communicate wirelessly (e.g., Bluetooth, Wi-Fi, etc.) with an electronic device, such as a portable electronic device (e.g., smartphone, tablet, laptop, wearable device, etc.). The device 100, 136, and/or 137 can emit sound communicated wirelessly from the electronic device, which can include sound streamed by the electronic device and/or sound received by a microphone of the electronic device. In some variants, the devices 100, 136, and/or 137 can communicate by way of a wired connection with the electronic device. In some variants, the devices 100, 136, and/or 137 can communicate through a network to computing devices.

In general, the word “controller,” as used herein, refers to logic embodied in hardware or firmware, or to a collection of software instructions, possibly having entry and exit points, written in a programming language, such as, for example, Java, C or C++. A software controller may be compiled and linked into an executable program, installed in a dynamic link library, or may be written in an interpreted programming language such as, for example, BASIC, Perl, or Python. It will be appreciated that controllers can include software modules that may be callable from other modules or from themselves, and/or may be invoked in response to detected events or interrupts. Software instructions may be embedded in firmware, such as an EPROM. It will be further appreciated that hardware controllers may be comprised of connected logic units, such as gates and flip-flops, and/or may be comprised of programmable units, such as programmable gate arrays or processors. The controllers described herein may be represented in software, hardware, or firmware. Generally, the controllers described herein can include logical modules that may be combined with other modules or divided into sub-modules despite their physical organization or storage.

The various illustrative logical blocks, controllers, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, controllers, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a filed programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Thus, it is intended that the scope of the inventions herein disclosed should not be limited by the particular embodiments described above.

What is claimed is:

1. A USB device for pranking an unsuspecting person, the USB device comprising:
a housing;
a USB connector configured to interface with a USB port of a device to power the USB device;
a loudspeaker disposed within the housing;
a user interface accessible outside of the housing, the user interface configured to be manipulated by a user to set a range of interval lengths; and
a controller connected to a physical memory disposed in the housing that comprises instructions that, when executed by the controller, cause:
the user interface to receive input from the user;
the controller to interpret the input; and
the loudspeaker to intermittently emit sound at random intervals within the set range of interval lengths.

2. The USB device of claim 1, wherein the USB device does not operate when not interfaced with the USB port of the device.

3. The USB device of claim 1, wherein the user interface is configured to be manipulated by the user to select the sound.

4. The USB device of claim 1, wherein the instructions, when executed by the controller, cause the loud speaker to intermittently emit random sound.

5. The USB device of claim 4, wherein the random sound is randomly selected from a plurality of sounds.

6. The USB device of claim 5, wherein the user interface is configured to be manipulated by the user to establish the plurality of sounds.

7. The USB device of claim 1, wherein the sound is music, an animal sound, or a human sound.

8. The USB device of claim 1, wherein the housing comprises a rectangular prism shape.

9. The USB device of claim 1, wherein the housing comprises one or more apertures through which sound emitted by the loudspeaker can travel.

10. An USB device for pranking an unsuspecting person, the USB device comprising:
a housing;
a USB connector configured to interface with a USB port of a device to power the USB device;
a loudspeaker disposed within the housing; and
a controller connected to a physical memory disposed in the housing that comprises instructions that, when executed by the controller, cause the loudspeaker to intermittently emit a sound at random interval lengths.

11. The USB device of claim 10, wherein the USB device does not operate when not interfaced with the USB port of the device.

12. The USB device of claim 10, wherein the random interval lengths are within a range of interval lengths.

13. The USB device of claim 12, further comprising a user interface configured to be manipulated by a user to set the range of interval lengths.

14. The USB device of claim 10, wherein the sound is random.

15. The USB device of claim 14, wherein the sound is randomly selected from a plurality of sounds.

16. An outlet device for pranking an unsuspecting person, the outlet device comprising:
a housing;
a connector configured to operatively connect with an interface of a power source to receive electrical current to power the outlet device;
one or more outlets configured to interface with another device to provide electrical current received by the outlet device to the another device;
a loudspeaker disposed within the housing; and
a controller connected to a physical memory disposed in the housing that comprises instructions that, when executed by the controller, cause the loudspeaker to intermittently emit sound.

17. The outlet device of claim 16, wherein the power source comprises a wall outlet.

18. The outlet device of claim 16, wherein the connector comprises prongs.

19. The outlet device of claim 16, wherein the housing comprises a front face, the front face comprising the one or more outlets and one or more apertures through which the intermittently emitted sound is projected.

20. The outlet device of claim 16, wherein the instructions, when executed by the controller, cause the loudspeaker to intermittently emit the sound at random interval lengths.
